(19) United States
(12) Patent Application Publication
(10) Pub. No.: US 2009/0229805 A1
(43) Pub. Date: Sep. 17, 2009

(54) MANIFOLD DESIGN HAVING AN IMPROVED COLLECTOR CONDUIT AND METHOD OF MAKING SAME

(75) Inventors: Henry Earl Beamer, Middleport, NY (US); Russell S. Johnson, Tonawanda, NY (US); Donald Robert Pautler, Lockport, NY (US); Douglas Charles Wintersteen, Burt, NY (US); Yanping Xia, North Tonawanda, NY (US)

Correspondence Address: DELPHI TECHNOLOGIES, INC., M/C 480-410-202, PO BOX 5052, TROY, MI, 48007, US

(73) Assignee: DELPHI TECHNOLOGIES, INC., Troy, MI (US)

(21) Appl. No.: 12/403,477

(22) Filed: Mar. 13, 2009

Related U.S. Application Data
(60) Provisional application No. 61/069,221, filed on Mar. 13, 2008.

(51) Int. Cl. F28F 9/02; F28D 7/16; B23P 15/26

(52) U.S. Cl. 165/174; 165/176; 29/890.052

(57) ABSTRACT

A heat exchanger assembly having an inlet header, an outlet header spaced apart from and substantially parallel the inlet header, and a plurality of refrigerant tubes each extending between and in hydraulic communication with the inlet header and outlet header. Contained within the outlet header is a refrigerant collector conduit adapted to provide a predetermined pressure drop (ΔP) and having a cross-section area A_{collector}. The refrigerant collector includes a plurality of orifices having a cumulative orifice area (nA_{orifice}) that are substantially equally spaced along the refrigerant collector. The collector conduit is in fluid communication with the outlet header for transferring the vapor phase of a two refrigerant. The collector conduit cross sectional area (A_{collector}) and cumulative orifice area (nA_{orifice}) is described by the following equation:

$$Δ p = \frac{{m}_{dot}^{2}}{ρ} [ \begin{matrix}467.892 ( \frac{1}{{A}_{collector}^{2}} - \frac{1}{{n}^{2} {A}_{orifice}^{2}} ) + \\ 51.25192 ( \frac{δ}{{D}_{orifice}} ) ( \frac{1}{n {A}_{orifice}^{2}} )\end{matrix} ] .$$

### CROSS-REFERENCE TO RELATED APPLICATIONS

This application claims the benefit of U.S. Provisional Patent Application Ser. No. 61/069,221 for a MANIFOLD DESIGN FOR IMPROVED REFRIGERANT DISTRIBUTION, filed on Mar. 13, 2008, which is hereby incorporated by reference in its entirety.

### TECHNICAL FIELD OF INVENTION

The subject invention relates generally to a heat exchanger having a plurality of refrigerant tubes extending between an inlet header and an outlet header for use with a two phase refrigerant undergoing a liquid to vapor transformation; more particularly to an improved refrigerant collector conduit disposed in the outlet header for uniformly collecting the vapor phase of the refrigerant.

### BACKGROUND OF THE INVENTION

Due to their high performance, automotive style brazed heat exchangers can be modified for residential and commercial air conditioning and heat pump applications. Automotive heat exchangers typically utilize a pair of manifold headers with multi-port extruded tubes defining fluid passages that interconnect the manifold headers. Corrugated air fins interconnect the tubes for improved heat transfer between the extruded tubes and ambient air. In modified automotive heat exchangers for residential applications, uniform refrigerant distribution through the manifolds and extruded tubes is necessary for optimal performance.

Modified automotive style brazed heat exchangers can be used as indoor and outdoor heat exchanger coils in residential and commercial air conditioning and heat pump systems. In cooling mode the indoor heat exchanger coil acts as the evaporator. In heating mode the outdoor heat exchanger coil acts as the evaporator. The substantially vertical refrigerant tubes interconnecting the substantially horizontal manifold headers of the automotive style heat exchanger form the core of the heat exchange coil. During operation in evaporative mode, partially expanded two phase refrigerant enters the lower portions of the refrigerant tubes where it continues to expand, absorbing heat from the air as it rises within the tube and changing into a vapor phase. Momentum and gravity effects due to the large mass differences between the liquid and gas phases can result in separation of the phases within the manifold and cause poor refrigerant distribution throughout the refrigerant tubes. This degrades evaporator performance and can result in hot spots over the core and in low temperature heating mode can result in increased icing or frosting of the core.

The increase in length requirement of the manifold header for residential and commercial as compared to automotive use dramatically increases the length of the manifold header where the two phase refrigerant needs to remain mixed without allowing the liquid to separate. Distributor tubes are used to obtain better refrigerant distribution in the inlet manifold header. These inlet distributors are intended to deliver partially expanded two phase refrigerant uniformly along their length. An example of such a heat exchanger having a refrigerant conduit is disclosed in U.S. Pat. No. 1,684,083 to S. C. Bloom.

Likewise, collector tubes are used to collect refrigerant in the outlet manifold header. These outlet collector tubes are intended to collect fully expanded gaseous refrigerant uniformly along their length. Since refrigerant is a gas at this point, its volume, vapor velocity, and the resulting pressure drop along the manifold or collector tube are much higher that if it remained in a liquid phase.

The increased length requirement of the manifold headers has produced increasing problems with refrigerant mal-distribution in the heat exchanger. Outlet pressure drop in the manifold headers reduces performance by both constraining refrigerant flow, inducing refrigerant flow mal-distribution, and raising the coil outlet pressure and temperature. Accordingly, there remains a need for an improved heat exchanger that provides for more uniform refrigerant distribution through out the coil.

### SUMMARY OF THE INVENTION AND ADVANTAGES

The present invention is a heat exchanger assembly having an inlet header, an outlet header spaced apart from and substantially parallel the inlet header, and a plurality of refrigerant tubes each extending between and in hydraulic communication with the inlet header and outlet header. Contained within the outlet header is a refrigerant collector conduit adapted to provide a predetermined pressure drop (ΔP) and having a cross-section area A_{collector}. The refrigerant collector includes a plurality of orifices having a cumulative orifice area (nA_{orifice}) that are spaced along the refrigerant collector. The collector conduit is in fluid communication with the outlet header for transferring the vapor phase of a two-phase refrigerant. The collector conduit cross sectional area (A_{collector}) and cumulative orifice area (nA_{orifice}) are described by the equation:

$$Δ p = \frac{{m}_{dot}^{2}}{ρ} [ \begin{matrix}467.892 ( \frac{1}{{A}_{collector}^{2}} - \frac{1}{{n}^{2} {A}_{orifice}^{2}} ) + \\ 51.25192 ( \frac{δ}{{D}_{orifice}} ) ( \frac{1}{n {A}_{orifice}^{2}} )\end{matrix} ]$$

wherein:

ΔP=predetermined collector pressure drop (psi);

m_{dot}=refrigerant mass flow (lbm/min);

ρ=refrigerant density (lbm/ft³);

A_{collector}=cross sectional area of collector (mm²);

A_{orifice}=average orifice cross sectional area (mm²);

$${A}_{ovifice} = \frac{{\sum }_{i} {A}_{orifice , i}}{n}$$

n=number of orifices;

D_{orifice}=average orifice diameter (mm); and

δ=collector thickness (mm).

The invention also provides a method of making a heat exchanger assembly that includes calculating the cumulative orifice area (nA_{orifice}) and collector cross-sectional area (A_{collector}) when

$$\frac{{A}_{collector}}{n {A}_{orifice}} = 0.5$$

utilizing the equation:

$$Δ p = \frac{{m}_{dot}^{2}}{ρ} [ \begin{matrix}467.892 ( \frac{1}{{A}_{collector}^{2}} - \frac{1}{4 {A}_{collector}^{2}} ) + \\ 51.25192 ( \frac{δ}{{D}_{orifice}} ) ( \frac{n}{4 {A}_{collector}^{2}} )\end{matrix} ]$$

Accordingly, the present invention improves refrigerant distribution within a heat exchanger by increasing the cross-sectional area of the refrigerant conduit to decrease the fluid flow velocity of a refrigerant in the refrigerant conduit to thereby decrease the pressure drop along the refrigerant conduit.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a cross-sectional view of an embodiment of the heat exchanger assembly showing the conduit body portion.

FIG. 2 is a perspective, fragmentary, and cross-sectional view of the heat exchanger assembly shown in FIG. 1 along 2-2 showing the refrigerant conduit having a cross sectional area and a plurality orifices;

FIG. 3 is cross-sectional view of the heat exchanger assembly shown in FIG. 1 along 2-2 showing the collector conduit having a conduit cross-sectional area A_{collector}.

FIG. 4 is a thermal image showing an example of poor refrigerant distribution of a 2 phase refrigerant within a test unit.

FIG. 5 shows plot for the ratio of various collector setups, where the ratio is varied, against the measured refrigerant distribution slope for the setup.

FIG. 6 shows the relationship between heat transfer performance and the area ratio.

FIG. 7 shows normalized heat transfer per square foot of core face area with respect to measured collector pressure drop.

FIG. 8 shows the predicted pressure drop using the correlation, shown as Equation 1, is plotted against the measured pressure drop.

FIG. 5 shows 2 outlet manifold sizes (denoted by ‘large’ and ‘extra large’) tested with and without collector (‘large heart’), respectively.

### DETAILED DESCRIPTION OF THE EXEMPLARY EMBODIMENT

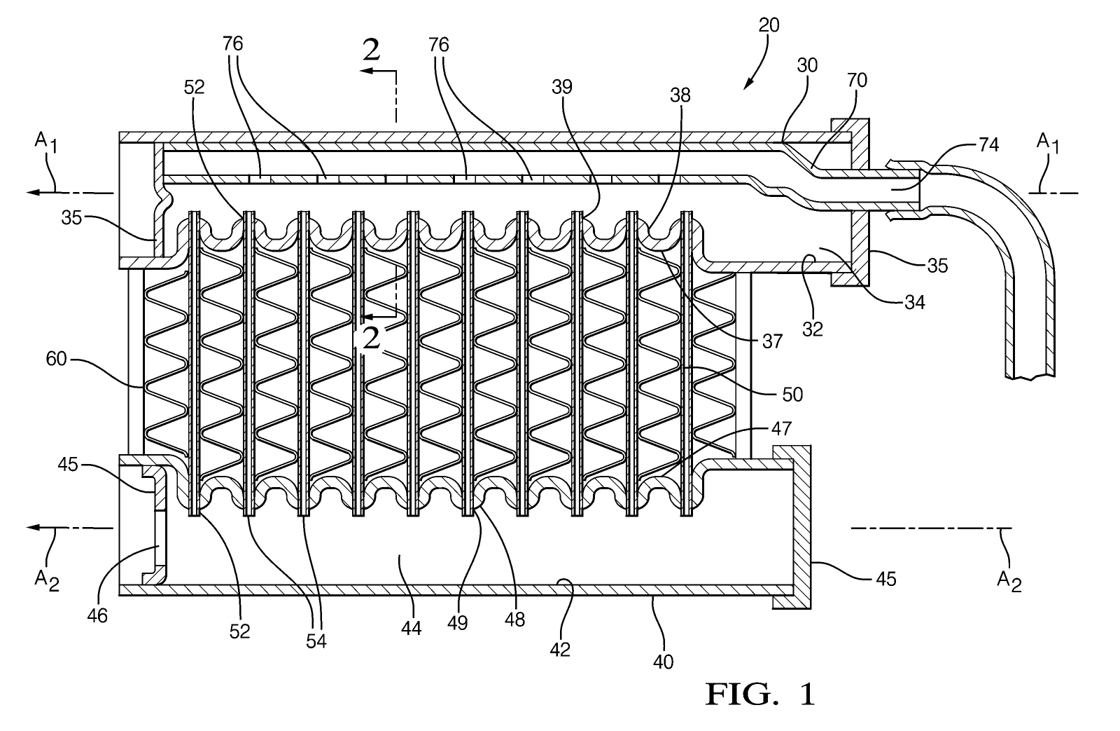

This invention will be further described with reference to the accompanying drawings, wherein like numerals indicate corresponding parts throughout the views. Shown in FIG. 1 is an automotive style brazed heat exchanger assembly 20 modified for stationary use in a residential or commercial setting. The heat exchanger assembly 20 includes an outlet header 30 in hydraulic communication with an inlet header 40 via a plurality of multi-port tubes 50. Interconnecting the extruded tubes are corrugated fins 60 for enhanced heat transfer and structural integrity of the heat exchanger assembly 20.

The outlet header 30 includes an interior surface 32 that is generally cylindrical or semi-cylindrical in cross-section located between opposing outlet header end caps 35. The interior surface 32 defines an outlet header cavity 34 extending along an outlet header axis A₁. Similarly, the inlet header 40 includes an inlet header interior surface 42 located between inlet header end caps 45 to define an inlet header cavity 44 extending along an inlet header axis A₂. The inlet header 40 further includes an inlet 46 for receiving a two phase refrigerant and may include an inlet distributor tube (not shown) for distributing the refrigerant uniformly. The outlet header axis A₁ is parallel to and substantially parallel to the inlet header axis A₂; therefore, the outlet header 30 is also parallel to and substantially parallel to the inlet header 40.

Each of the headers 30, 40 includes a lanced surface 37, 47 extending between the corresponding header end caps 35, 45 and parallel to the corresponding header axis A₁, A₂. The lanced surfaces 37, 47 of each header are oriented toward each other and include a plurality of truncated projections 38, 48 extending into the corresponding cavity 34, 44. The truncated projections 38, 48 define a plurality of header slots 39, 49 extending transversely to the header axes A₁, A₂.

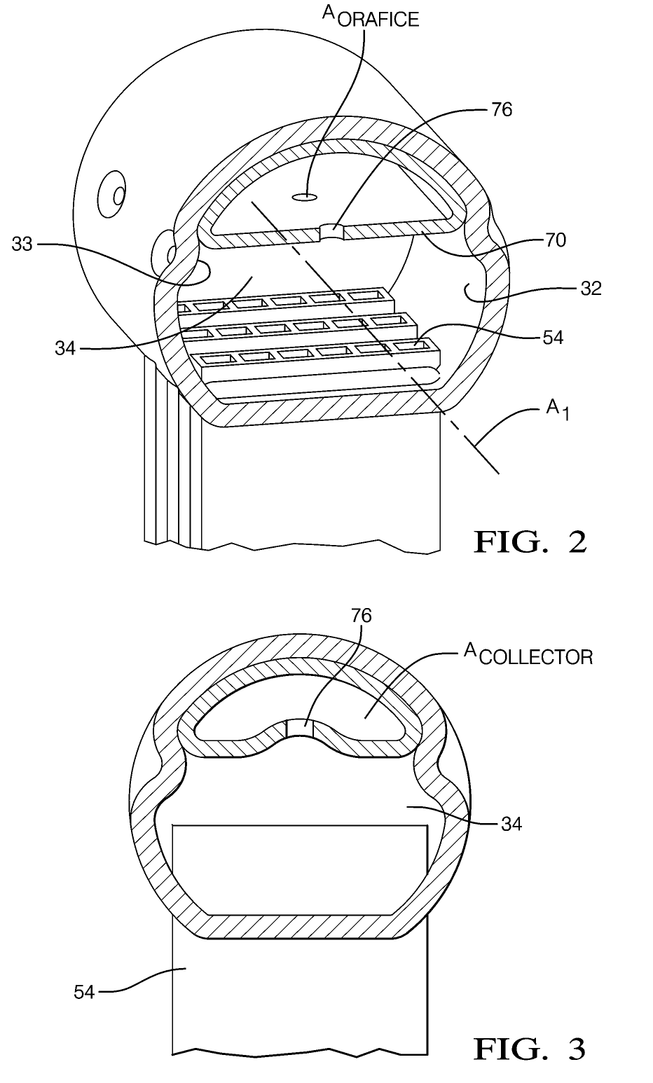

A plurality of refrigerant tubes 50 extend in a spaced and parallel relationship and transversely to the header axes A₁, A₂ between the headers 30, 40. Each of the refrigerant tubes 50 defines a fluid passage 54, and shown in FIG. 2 extending between the refrigerant tube ends 52. The refrigerant tube ends 52 of each refrigerant tube 50 extend through one of the corresponding header slots 39, 49 of each header 30, 40. Each fluid passage 54 is in fluid communication with the cavities 34, 44 for transferring refrigerant from the inlet header 40 to the outlet header 30. A plurality of cooling heat transfer fins 60 is disposed between adjacent refrigerant tubes 50 for increased heat transfer. The heat transfer fins 52 may be serpentine fins or any other heat transfer fins commonly known in the art.

A two phase refrigerant is introduced into the inlet header 40 where the refrigerant is then uniformly distributed to the extruded tubes 50. In evaporative mode, the two phase refrigerant undergoes a liquid-to-vapor transformation as it absorbs heat from the ambient air as the refrigerant flows within the refrigerant tube 50 from the inlet header 40 to the outlet header 30. Contained within the outlet header cavity 34 is a collector conduit 70 to provide for the collection and transportation of the vapor phase of the refrigerant out of the outlet header 30.

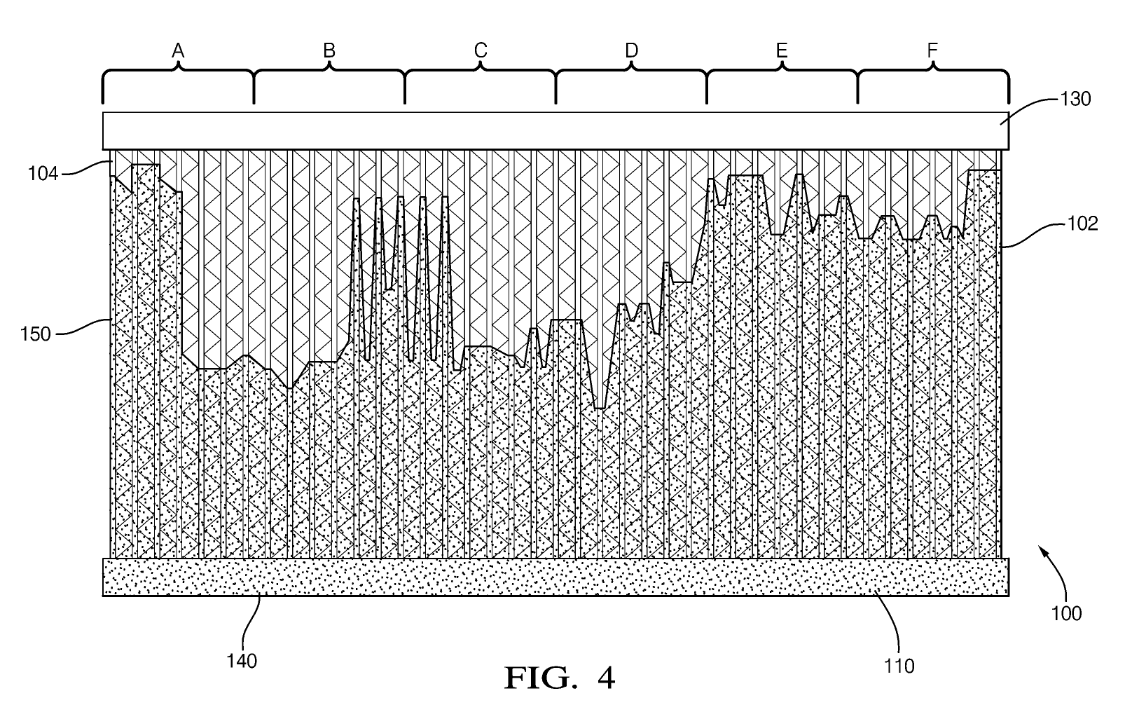

Shown in FIG. 2, the refrigerant collector conduit 70 extends substantially parallel to the outlet header axis A₁ within the outlet header cavity 34 and supported by protrusions 33 spaced along the outlet header interior surface. Shown in FIG. 3, the collector conduit cross-sectional area A_{collector} may be substantially circular, semi-circular, or heart shaped. Shown in FIG. 1, the collector conduit 70 includes an outlet end 74 that extends through one of outlet header end caps 35. As an alternative embodiment (not shown), the collector conduit may include two opposite facing outlet ends, in which each outlet end extends through its respective outlet header end caps. The collector conduit 70 includes a plurality of orifices 76 in fluid communication within the outlet header cavity 34 for collecting the refrigerant vapor.

The plurality of orifices 76 are substantially equally spaced along the length of the collector conduit 70. As an alternative embodiment (not shown), the shape, size, and spacing of the orifices 76 can be varied along the length of the refrigerant conduit 70 to achieve uniform refrigerant distribution throughout the heat exchanger assembly 20. Shown in FIG. 2, each orifice has an area A_{orifice,i}. The orifices 76 may be punched, drilled, lanced, or manufactured by any known means in the art. The proper sizing of the orifices area A_{orifice,i} is important to the efficient operation of the heat exchanger assembly 20. The proper sizing can be represented as the ratio of the cumulative area of the orifice opening nA_{orifice}, in which n is the number of orifices and A_{orifice} is the average orifice area, to the cross sectional area of the collector A_{collector}.

A test unit was developed to evaluate the effects on refrigerant distribution of varying the cross-sectional area A_{collector} relative to the total orifice area nA_{orifice} of the collector conduit. The test unit represents an operating automotive type brazed heat exchanger modified to be used as an evaporator for residential or commercial application. Key geometric variables include coil size, manifold length, and manifold area. Shown in FIG. 4 is thermo-graphic image 100 of the front view of the test unit 110. The test unit 110 includes an outlet header 130, an inlet header 140, and a plurality of vertical tubes 150 in hydraulic communications with both headers 130, 140. A two phase refrigerant is distributed to the vertical tubes 150 extending from the inlet header 140 to the outlet header 130. As the two phrase refrigerant flows through the vertical tubes 150 to the top header, the liquid phase changes to gas phase by the absorption of heat from the ambient air. The darker areas 102 of the thermo-graphic image 110 represents the liquid/gaseous phase region within the vertical tubes 150 and the lighter areas 104 represent the superheated gas phase region of the refrigerant. The gas phase of the refrigerant is collected in the outlet header 130 by a collector conduit (not shown) having a plurality of orifices. Shown in FIG. 4 is a thermal image of a test unit having poor refrigerant distribution through the coil, which is indicated by the varying heights of the dark areas. A good distribution through the coil (not shown) would be indicated by the dark area being substantially level.

The thermo-graphic image 100 shows an example of a single test of the experiment where the number and size of the orifice areas are changed relative to the cross-sectional area of the collector conduit. The thermo-graphic image 100 shows an exemplary poor refrigerant distribution for test unit 110. The test unit 110 was divided into 6 approximately equal sections. An average height for each section was visually estimated and marked. The distribution metric that correlates best with flow geometry factors is the slope rating:

$$Slope = \frac{( height section 6 - height section 1 )}{( height section 6 )}$$

Since the slope can be positive or negative, it gives a directional indication of distribution. A slope equal to zero indicates perfect distribution. In other words, where the dark peaks are of equal height across the thermo-graphic image 100, the refrigerant flow is equally distributed across the test unit. It was found that the refrigerant distribution can be controlled by varying the ratio of the collector's cross sectional area (A_{collector}) to the collector's total orifice area (sum of the areas of the individual orifices) nA_{orifice}.

FIG. 5 shows a plot for the ratio of various collector setups, where the ratio is varied, against the measured refrigerant distribution slope for the setup. Shown on the y-axis is the ratio of the cross sectional area of the collector A_{collector} relative to the total area of the collector's orifices nA_{orifice}. Shown on the x-axis is the distribution slope for each test where the height of liquid/gas phase refrigerant in section 1 is compared to the height of liquid/gas phase refrigerant in section 6. The y-axis (A_{collector}/nA_{orifice}) crosses the x-axis (distribution slope) at 0. A slope equal to zero indicates perfect distribution of refrigerant across the face of the test unit. A linear curve fit to the data points crosses the y-axis (where distribution slope=0) at about 0.5. Therefore, optimum refrigerant distribution occurs when

$$\frac{{A}_{collector}}{n {A}_{orifice}} = 0.5 .$$

Where A_{collector} is the cross-section area of the collector, A_{orifice} is the average open area of each orifice, and n is the number of orifices.

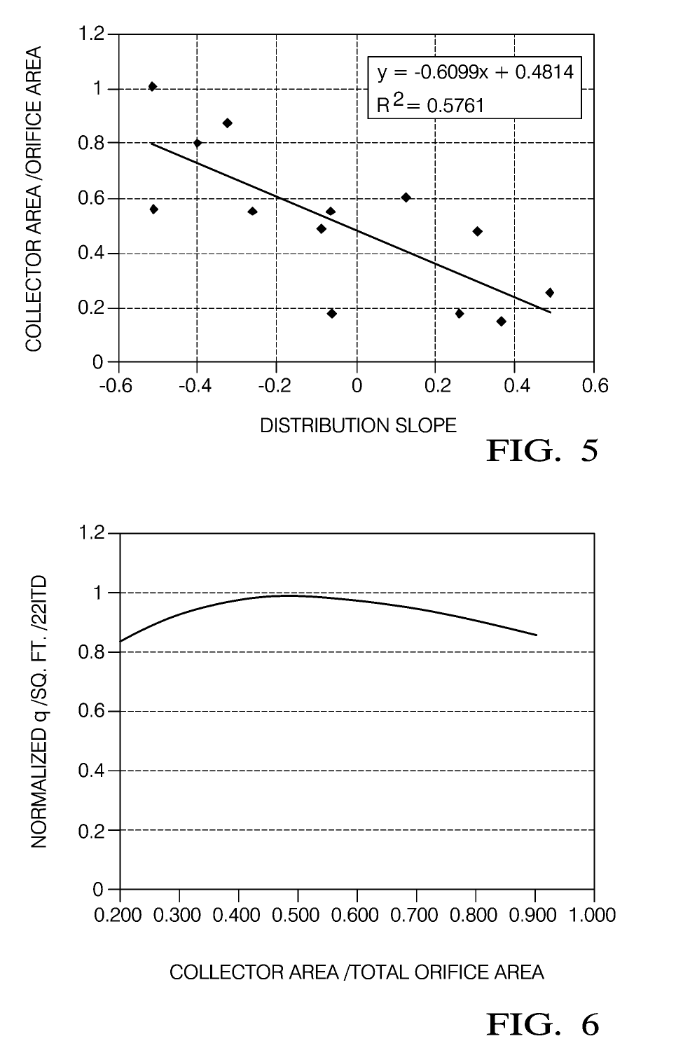

Refrigerant distribution has a significant effect on heat exchanger performance as it affects the percentage of frontal area that is at saturation temperature. By varying the ratio of the collector's cross sectional area (A_{collector}) to the collector's cumulative orifice area (sum of the areas of the individual orifices) nA_{orifice}, different refrigerant distribution and thus different performance levels can be achieved. FIG. 6 shows the relationship between heat transfer performance and the area ratio. The x-axis is the ratio of the cross sectional area of the collector A_{collector} relative to the total area of the collector's orifices nA_{orifice}. The y-axis is the heat transfer per square foot of core face area corrected to 22° F. difference between air and refrigerant inlet temperatures (ITD), normalized to the maximum number within the range. Doing so eliminates the effect of collector pressure drop on the average saturation temperature and focuses on the effect of the area ratio on refrigerant distribution only. The plot, again, demonstrates the optimum ratio of 0.5 where highest performance can be achieved. Moreover, it shows that within the range of area ratio 0.18 to 0.79, performance loss from perfect distribution is controlled within 20%; within the range of 0.33 to 0.63, performance loss is controlled within 10%; and within the range of 0.45 to 0.51, performance loss is controlled within 5%.

As a summary, to design collector orifice pattern that controls performance loss from perfect distribution to be within 20%, 10%, and 5%, the ranges of the area ratio, respectively, are:

$$\begin{matrix}0.18 \leq \frac{{A}_{collector}}{{\sum }_{i} {A}_{orifice , i}} \leq 0.79 \\ 0.33 \leq \frac{{A}_{collector}}{{\sum }_{i} {A}_{orifice , i}} \leq 0.63 \\ 0.45 \leq \frac{{A}_{collector}}{{\sum }_{i} {A}_{orifice , i}} \leq 0.51\end{matrix}$$

In the above equations A_{collector} is the cross-section area of the collector, and A_{orifice,i} is the open area of each individual orifice. The area ratio for perfect refrigerant distribution is:

$$\frac{{A}_{collector}}{{\sum }_{i} {A}_{orifice , i}} = 0.5$$

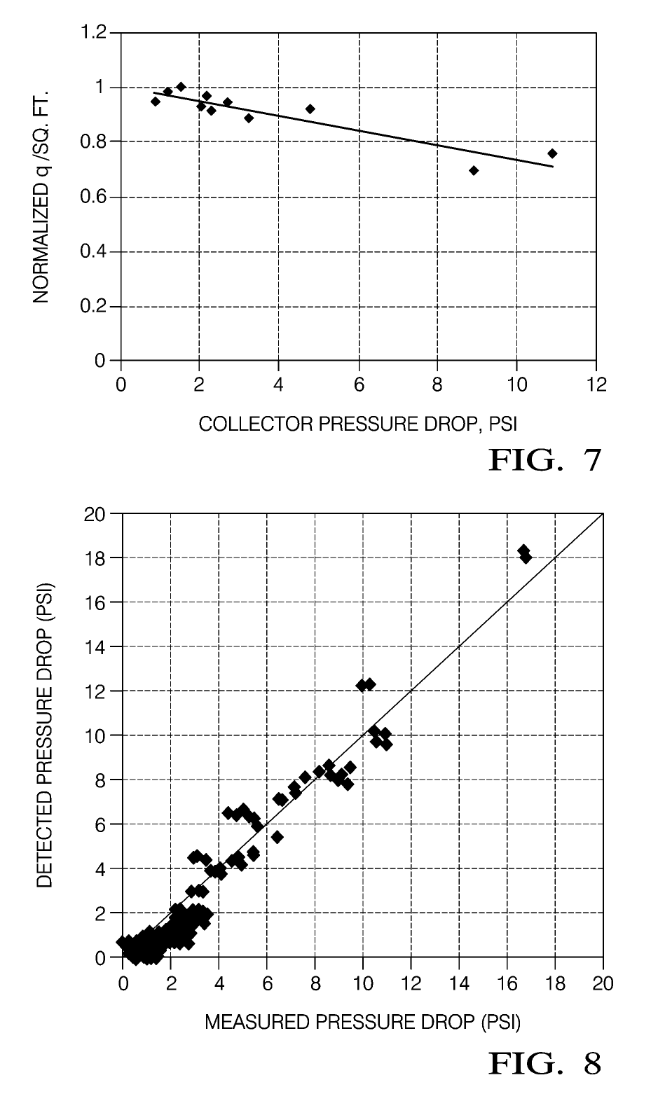

It was found that the pressure drop of the refrigerant distribution system (collector) has a strong effect on heat transfer performance. The manifold and collector pressure drop increases refrigerant saturation temperature in the tubes and therefore reduces the effective temperature difference between the refrigerant and air. The pressure drop was evaluated between ports located in the center of the outlet manifold and the outlet pipe. FIG. 7 shows a plot of normalized heat transfer per square foot of core face area with respect to measured collector pressure drop. The performance penalty is 14.3% corresponding to 5 psi pressure drop, that is, the performance penalty is 2.9% per psi pressure drop.

A theoretical performance penalty can be predicted based on refrigerant saturation pressure vs. saturation temperature relationship: for R134a the saturation curve slope is 0.778° F. sat/psi; a 5 psi pressure drop reduces ITD by 5*0.778=3.89° F.; for a 22° F. ITD test, that means a performance penalty of 3.89/22=17.7%, that is, 3.5% per psi pressure drop. Reasonable agreement was obtained between the theoretical & measured performance penalty. Given a refrigerant saturation curve slope (° F. per psi) and nominal ITD, to limit performance penalty to 20% theoretical, the collector pressure drop should be less than:

$$Δ p \leq \frac{20 \% ITD}{Saturation\_Curve \_Slope}$$

For R134a and 22° F. ITD specifically, to limit performance penalty to 20%, 15%, and 9% of theoretical, the collector pressure drop should be less than 7, 5, and 3 psi respectively.

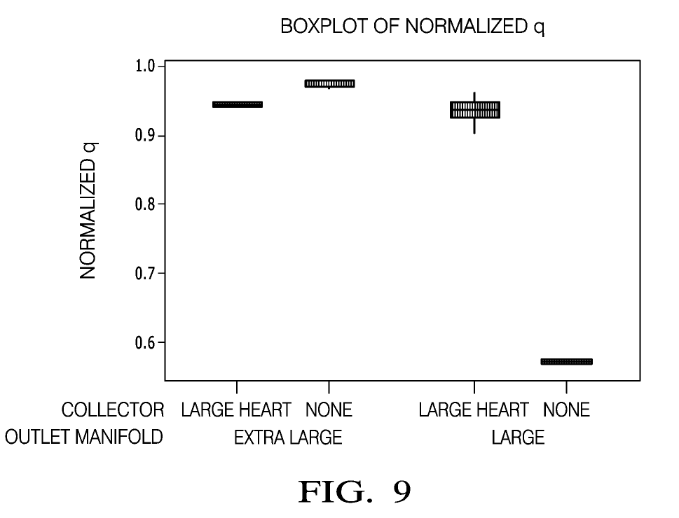

It was found that manifold and collector geometry could be correlated with collector/manifold pressure drop. The pressure drop was evaluated between ports located in the center of the outlet manifold and the outlet pipe. An expression based on Bernoulli's equation was developed and coefficients were determined by a linear regression to the test data. The predicted pressure drop using the correlation, shown as Equation 1, is plotted against the measured pressure drop, as shown in FIG. 8.

The correlation predicts the measured pressure drop well.

Equation 1

$Δp = \frac{{m}_{dot}^{2}}{ρ} [ \begin{matrix}467.892 ( \frac{1}{{A}_{collector}^{2}} - \frac{1}{{n}^{2} {A}_{orifice}^{2}} ) + \\ 51.25192 ( \frac{δ}{{D}_{orifice}} ) ( \frac{1}{{nA}_{orifice}^{2}} )\end{matrix} ]$

| Parameter | Symbol | units |
|---|---|---|
| collector pressure drop | ΔP | psi |
| refrigerant mass flow | m_{dot} | lbm/min |
| refrigerant density | ρ | lbm/ft 3 |
| Collector cross sectional area | A_{collector} | mm 2 |
| Average cross sectional area/orifice | A_{orifice} | mm 2 |
| ${A}_{ovifice} = \frac{{\sum }_{i} {A}_{orifice , i}}{n}$ | | |
| number of orifices | n | |
| average orifice diameter | D_{orifice} | mm |
| collector thickness | δ | mm |

Note that pressure drop and the required collector and orifice areas to achieve a required maximum pressure drop are strongly dependant on the refrigerant flow rate and density. This means that manifold/collector design must be sized for the intended heat transfer rate and refrigerant.

For the case of optimum refrigerant distribution where

$$\frac{{A}_{collector}}{n {A}_{orifice}} = 0.5$$

the new correlation is shown as equation 2 below:

$$Δ p = \frac{{m}_{dot}^{2}}{ρ} [ \begin{matrix}467.892 ( \frac{1}{{A}_{collector}^{2}} - \frac{1}{4 {A}_{collector}^{2}} ) + \\ 51.25192 ( \frac{δ}{{D}_{orifice}} ) ( \frac{n}{4 {A}_{collector}^{2}} )\end{matrix} ] \qquad Equation 2$$

For uniform orifice size, Equations 1 and 2 above may be used in calculating the optimal A_{collector} to nA_{orifice} ratio for fabricating a heat exchanger. The method includes the steps of:

Starting with predetermined number of orifices n:
i. estimating an initial orifice diameter ‘D_{orifice, old}’, and calculating ‘A_{collector}’ using:

$$Δ p = \frac{{m}_{dot}^{2}}{ρ} [ \begin{matrix}467.892 ( \frac{1}{{A}_{collector}^{2}} - \frac{1}{4 {A}_{collector}^{2}} ) + \\ 51.25192 ( \frac{δ}{{D}_{orifice}} ) ( \frac{n}{4 {A}_{collector}^{2}} )\end{matrix} ]$$

wherein, said Δp is a predetermined pressure drop;
ii. calculating ‘A_{orifice}’ using:

$$\frac{{A}_{collector}}{n {A}_{orifice}} = 0.5$$

iii. updating ‘D_{orifice, new}’ using:

$${A}_{orifice} = \frac{π {D}_{orifice}^{2}}{4}$$

iv. determining if |D_{orifice, new}−D_{orifice, old}|<0.1 mM; if “yes”, then use calculated A_{orifice} and A_{collector}, if “no”, then go back to step i using updated ‘D_{orifice,new}’ as ‘D_{orifice,old}’, and iterate through steps i-iv until |D_{orifice,new}−D_{orifice,old}|<0.1 mm.

An alternative is to start with predetermined orifice area A_{orifice}:
i. estimating an initial orifice number ‘n_{old}’, and calculating ‘A_{collector}’ using:

$$Δ p = \frac{{m}_{dot}^{2}}{ρ} [ \begin{matrix}467.892 ( \frac{1}{{A}_{collector}^{2}} - \frac{1}{4 {A}_{collector}^{2}} ) + \\ 51.25192 ( \frac{δ}{{D}_{orifice}} ) ( \frac{n}{4 {A}_{collector}^{2}} )\end{matrix} ]$$

wherein, said Δp is a predetermined pressure drop;
ii. calculating updated ‘n_{new}’ using:

$$\frac{{A}_{collector}}{n {A}_{orifice}} = 0.5$$

iii. determining if |n_{new}−n_{old}|<1; if “yes”, then use calculated n and A_{collector}, if “no”, then go back to step 1 using updated ‘n_{new}’ as ‘n_{old}’, and iterate through steps i-iii until |n_{new}−n_{old}|<1.

It was found that smaller inlet manifold cross-section area improves performance by promoting mixing of liquid and gas refrigerant and thus improving refrigerant distribution. It was further found that the need for the collector conduit can be eliminated if the outlet manifold cross section is big enough. Shown in FIG. 9 are 2 outlet manifold sizes (denoted by ‘large’ and ‘extra large’) tested with and without collector (‘large heart’), respectively. While the performance for the core with ‘large’ outlet manifold was greatly improved by use of collector, performance for ‘extra large’ outlet manifold was even higher without collector.

To design a manifold that is large enough to work without a collector, it should be sized per the following relationship:

Equation 3

$Δp = \frac{{m}_{dot}^{2}}{ρ} [ 883 \times ( \frac{1}{{A}_{manifold}^{2}} - \frac{1}{{n}^{2} {A}_{tube}^{2}} ) ] \leq 0.5 psi ,$

| Parameter | Symbol | units |
|---|---|---|
| manifold pressure drop | ΔP | psi |
| refrigerant mass flow | m_{dot} | lbm/min |
| refrigerant density | ρ | lbm/ft 3 |
| Manifold cross sectional area | A_{manifold} | mm 2 |
| Average cross sectional area/tube | A_{tube} | mm 2 |

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A heat exchanger assembly for transferring heat comprising:
an inlet header extending along an inlet header axis;
an outlet header defining an outlet header cavity extending along an outlet header axis spaced apart from and substantially parallel to said inlet header axis;
said headers include a plurality of corresponding header slots;
a plurality of refrigerant tubes each extending between said header slots and defining a fluid passage for refrigerant flow between said headers; and
a refrigerant collector conduit adapted to provide a predetermined pressure drop (ΔP) and having a cross-section area A_{collector} and disposed in said outlet header cavity and extending along said outlet header axis;
wherein said refrigerant collector includes a plurality of orifices having a cumulative orifice area (nA_{orifice}) and spaced along said refrigerant collector conduit in fluid communication with said outlet header cavity for transferring the refrigerant between said refrigerant collector conduit and said outlet header cavity; and
wherein said collector conduit cross sectional area (A_{collector}) and cumulative orifice area (nA_{orifice}) are described by the equation:
$$Δ p = \frac{{m}_{dot}^{2}}{ρ} [ \begin{matrix}467.892 ( \frac{1}{{A}_{collector}^{2}} - \frac{1}{{n}^{2} {A}_{orifice}^{2}} ) + \\ 51.25192 ( \frac{δ}{{D}_{orifice}} ) ( \frac{1}{n {A}_{orifice}^{2}} )\end{matrix} ]$$
wherein:
ΔP=predetermined collector pressure drop (psi);
m_{dot}=refrigerant mass flow (lbm/min);
ρ=refrigerant density (lbm/ft³);
A_{collector}=cross sectional area of collector (mm²);
A_{orifice}=average orifice cross sectional area (mm²);
$${A}_{ovifice} = \frac{{\sum }_{i} {A}_{orifice , i}}{n}$$
n=number of orifices;
D_{orifice}=average orifice diameter (mm); and
δ=collector thickness (mm).

2. The heat exchanger assembly of claim 1, wherein said refrigerant collector conduit is adapted to provide a collector pressure drop (ΔP_{collector}) equal to or less than 7 psi during operating conditions.

3. The heat exchanger assembly of claim 1, wherein said refrigerant collector conduit is adapted to provide a collector pressure drop (ΔP_{collector}) equal to or less than 5 psi during operating conditions.

4. The heat exchanger assembly of claim 1, wherein said refrigerant collector conduit is adapted to provide a collector pressure drop (ΔP_{collector}) equal to or less than 3 psi during operating conditions.

5. The heat exchanger assembly of claim 1, wherein said collector conduit cross sectional area (A_{collector}) to cumulative orifice area (nA_{orifice}) has a ratio within the range of 0.2 and 0.8.

6. The heat exchanger assembly of claim 1, wherein said collector conduit cross sectional area (A_{collector}) to cumulative orifice area (nA_{orifice}) has a ratio within the range of 0.3 and 0.7.

7. The heat exchanger assembly of claim 1, wherein said collector conduit cross sectional area (A_{collector}) to cumulative orifice area (nA_{orifice}) has a ratio within the range of 0.4 and 0.6.

8. The heat exchanger assembly of claim 1, wherein said refrigerant collector conduit is adapted to provide a collector pressure drop (ΔP_{collector}) equal to or less than 7 psi during operating conditions and said collector conduit cross sectional area (A_{collector}) to cumulative orifice area (nA_{orifice}) has a ratio within the range of 0.2 and 0.8.

9. The heat exchanger assembly of claim 1, wherein said refrigerant collector conduit is adapted to provide a collector pressure drop (ΔP_{collector}) equal to or less than 7 psi during operating conditions and wherein said collector conduit cross sectional area (A_{collector}) to cumulative orifice area (nA_{orifice}) has a ratio within the range of 0.3 and 0.7.

10. The heat exchanger assembly of claim 1, wherein said refrigerant collector conduit is adapted to provide a collector pressure drop (ΔP_{collector}) equal to or less than 7 psi during operating conditions and wherein said collector conduit cross sectional area (A_{collector}) to cumulative orifice area (nA_{orifice}) has a ratio within the range of 0.4 and 0.6.

11. The heat exchanger assembly of claim 1, wherein said outlet header includes an outlet header diameter and said inlet header includes an inlet header diameter, said outlet header diameter is greater than said inlet header diameter.

12. A heat exchanger assembly of claim 1, wherein said inlet header includes an inlet volume and said outlet includes an outlet volume, wherein said outlet header volume is greater than said inlet header volume.

13. A heat exchanger assembly for transferring heat comprising:
an inlet header extending along an inlet header axis;
an outlet header defining an outlet header cavity extending along an outlet header axis spaced apart from and substantially parallel to said inlet header axis;
said headers include a plurality of corresponding header slots;
a plurality of refrigerant tubes each extending between said header slots and defining a fluid passage for refrigerant flow between said headers; and
a refrigerant collector conduit having a cross-section area A_{collector} and disposed in said outlet header cavity and extending along said outlet header axis;
wherein said refrigerant collector conduit is adapted to provide a pressure drop equal to or less than 7 psi during operating conditions and includes a plurality of orifices having a cumulative orifice area nA_{orifice} and spaced along said refrigerant collector conduit in fluid communication with said outlet header cavity for transferring the refrigerant between said refrigerant collector conduit and said outlet header cavity.

14. The heat exchange assembly of claim 13, wherein said refrigerant collector conduit is adapted to provide a pressure drop equal to or less than 5 psi during operating conditions.

15. The heat exchange assembly of claim 13, wherein said refrigerant collector conduit is adapted to provide a pressure drop equal to or less than 3 psi during operating conditions.

16. A method for fabricating a heat exchanger assembly comprising the steps of;
providing a plurality of extruded refrigerant tubes;
providing a generally cylindrical outlet header defining an outlet header cavity;
providing a generally cylindrical inlet header;
puncturing said outlet header and outlet header in predetermined spaced intervals to define a plurality of corresponding header slots spaced along each of said headers;
providing a collector conduit having a collector conduit cross-section area A_{collector};
producing a plurality of orifices having a cumulative orifice area nA_{orifice} in said collector conduit,
assembling said refrigerant collector conduit into said cavity of said outlet header; and
inserting said refrigerant tubes to said header slots;
wherein said collector conduit cross sectional area A_{collector} and said cumulative orifice area nA_{orifice} is determined by starting with predetermined number of orifices n:
i. estimating an initial orifice diameter ‘D_{orifice, old}’, and calculating ‘A_{collector}’ using:
$$Δ p = \frac{{m}_{dot}^{2}}{ρ} [ \begin{matrix}467.892 ( \frac{1}{{A}_{collector}^{2}} - \frac{1}{4 {A}_{collector}^{2}} ) + \\ 51.25192 ( \frac{δ}{{D}_{orifice}} ) ( \frac{n}{4 {A}_{collector}^{2}} )\end{matrix} ]$$
wherein, said Δp is a predetermined pressure drop;
ii. calculating ‘A_{orifice}’ using:
$$\frac{{A}_{collector}}{n {A}_{orifice}} = 0.5$$
iii. calculating the value of ‘D_{orifice, new}’ using:
$${A}_{orifice} = n \frac{π {D}_{orifice}^{2}}{4}$$
iv. determining if |D_{orifice, new}−D_{orifice, old}|<0.1 mm; if “yes”, then use calculated A_{orifice} and A_{collector}, if “no”, then go back to step i using updated ‘D_{orifice, new}’ as ‘D_{orifice, old}’, and iterate through steps i-iv until |D_{orifice, new}−D_{orifice, old}|<0.1 mm.

17. A method for fabricating a heat exchanger assembly comprising the steps of;
providing a plurality of extruded refrigerant tubes;
providing a generally outlet header defining an outlet header cavity;
providing a generally inlet header;
puncturing said outlet header and outlet header in predetermined spaced intervals to define a plurality of corresponding header slots spaced along each of said headers;
providing a collector conduit having a collector conduit cross-section area A_{collector};
producing a plurality of orifices having a cumulative orifice area nA_{orifice} in said collector conduit,
assembling said refrigerant collector conduit into said cavity of said outlet header; and
inserting said refrigerant tubes to said header slots;
wherein said collector conduit cross sectional area A_{collector} and said cumulative orifice area nA_{orifice} is determined by starting with predetermined orifice open area A_{orifice}.
i. estimating an initial orifice number ‘n_{old}’, and calculating ‘A_{collector}’ using:
$$Δ p = \frac{{m}_{dot}^{2}}{ρ} [ \begin{matrix}467.892 ( \frac{1}{{A}_{collector}^{2}} - \frac{1}{4 {A}_{collector}^{2}} ) + \\ 51.25192 ( \frac{δ}{{D}_{orifice}} ) ( \frac{n}{4 {A}_{collector}^{2}} )\end{matrix} ]$$
wherein, said Δp is a predetermined pressure drop;
ii. calculating updated ‘n_{ew}’ using:
$$\frac{{A}_{collector}}{n {A}_{orifice}} = 0.5$$
iii. determining if |n_{new}−n_{old}|<1; if “yes”, then use calculated n and A_{collector}, if “no”, then go back to step 1 using updated ‘n_{new}’ as ‘n_{old}’, and iterate through steps i-iii until |n_{new}−n_{old}|<1.
